(19) United States
(12) Patent Application Publication
(10) Pub. No.: US 2014/0360397 A1
(43) Pub. Date: Dec. 11, 2014

(54) COMPOSITE IMAGE HEAT TRANSFERS

(71) Applicant: Avery Dennison Corporation, Mentor, OH (US)

(72) Inventor: Jeremy W WHITE, Kettering (GB)

(21) Appl. No.: 14/300,847

(22) Filed: Jun. 10, 2014

Related U.S. Application Data
(60) Provisional application No. 61/833,586, filed on Jun. 11, 2013.

(51) Int. Cl. B44C 1/17; B41M 7/00; B41M 5/26; B41M 5/50

(52) U.S. Cl. CPC B44C 1/1712; B41M 5/50; B41M 7/00; B41M 5/26
USPC 101/488; 428/32.6; 428/32.75

(57) ABSTRACT

Heat transfers are provided that have a symbol image which can be of a numeric, alphabetic or alpha-numeric shape and have a body width onto which another image is placed. The image thus placed can be of an individual or scene, for example, the image of a sport personality. The result is a composite image, and this composite image is imparted to a heat transfer support or substrate having heat transfer capabilities, such as by a printing technique. The resultant composite image heat transfer then is available for application onto products such as soft goods or other merchandise.

### CROSS-REFERENCE TO RELATED APPLICATION

The present application claims priority to U.S. Application No. 61/833,586, filed on Jun. 11, 2013 which is incorporated herein by reference in its entirety.

### BACKGROUND

1. Field

The present subject matter relates to heat transfer embellishments suitable for use for decorative or identification purposes on promotional and merchandised products. The present subject matter is especially suitable for merchandised products associated with sport, celebrities, movie, television themes or other entertainment. In accordance with embodiments of the present subject matter, composite image heat transfers for clothing are provided.

2. Description of Related Art

Heat transfer labels, patches, tags, identification placards, embellishments and the like are widely used for a variety of different applications, including product identifiers, clothing labels, decorative and embellishing additions to clothing, soft goods, hard goods and numerous other products. In one example, dry-release heat transfer labels are provided for objects such as plastic bottles. U.S. Pat. No. 3,922,435 illustrates such a label, which is formed by a resinous release layer on a suitable temporary carrier, with a transfer layer including a design print on the release layer and a heat-activatable thermoplastic adhesive layer upon the transfer layer. The composition is such that, at heat transfer temperatures, the relative strengths of the bond between the release and transfer layers and their cohesiveness permit the release layer, with its temporary carrier, to be stripped from the transfer layer which remains adhered to the object without leaving any substantial amount of the transfer layer with the release layer. This patent, as well as U.S. Pat. No. 5,972,481 and U.S. Pat. No. 8,350,880 include further details of heat transfer labels and selective heat transfer imaging, and all of these patents are incorporated herein by reference in their respective entireties.

In another example, heat transfer printing of photographic images is used in providing the image on a surface of a product. Some approaches for so proceeding provide for the photographic image to be recorded in thermoplastic resin. Details of thermal transfer printing material, coating compositions and energy application, substrate films, and dyes, including transfer and sublimation dyes and transfer printing details are provided in U.S. Pat. Nos. 5,175,139; 5,302,438; No. 6,615,714; No. 6,743,109 and No. 7,526,997, incorporated herein by reference in their respective entireties.

In other examples, multiple images and systems for selecting and transferring those images achieve imprinting onto a variety of surfaces, including so-called soft surfaces. U.S. Pat. No. 6,334,853; No. 6,414,693 and No. 6,793,688 and U.S. Patent Application Publication No. 2002/0062264, incorporated herein by reference in their respective entireties, provide details on these systems, images, products or goods subject to this technology, and chemicals and materials used in connection therewith.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

In one aspect of this disclosure, a heat transfer label or embellishment includes a substrate having an image applied to the substrate and one or more layers of pigment and/or adhesive exhibiting heat transfer characteristics or one that is capable of being transferred by heat and pressure, the heat transfer having a composite image on the substrate, the composite image being a famous person or image, such as a sport player image located within at least a portion of a numeric or alphabetic symbol, such as a number or a letter that might appear on a jersey or the like. As used herein the term “heat transfer” refers generally to a laminate which is used to create the heat transfer embellishment or label as described herein.

In another aspect, a heat transfer has a heat transfer embellishment exhibiting heat transfer characteristics and an image of a keyboard symbol that has spaced-apart perimeter outlines that define a body area therebetween, a composite image being formed by including an image of a sport player or other individual, scene or object within at least a portion of the keyboard symbol area. As used herein the term “keyboard symbol” refers to any symbol that is found on a keyboard, such as a quaternary keyboard, or a symbol that can be rendered by use of a keyboard such as by inserting various other symbols that may be accessible from a database or other standard set of symbols.

In a further aspect, a heat transfer has a heat transfer provided on a substrate, the heat transfer having heat transfer characteristics and a first image of a keyboard symbol that has spaced-apart perimeter outlines that define a body area therebetween, a composite image being formed by including a second image of a sport player or other individual, scene or object within at least a portion of the keyboard symbol area. Multiple first images are provided on the heat transfer substrate, and the second image is split between at least two different keyboard or placement symbol areas.

In yet another aspect of this disclosure, a heat transfer composite is prepared, including preparing a composite image of a sport player, celebrity, image or the like within a numeric or alphabetic image or some other background representing a particular theme, providing a substrate, reproducing this composite image on the substrate, the substrate being imparted with heat transfer characteristics before, during or after this reproducing of the composite image thereon, thereby providing the composite image heat transfer.

In a further aspect of the disclosure, a composite image heat transfer is manufactured by preparing a composite image that includes a first image of a keyboard or other symbol having spaced apart perimeter boundaries defining a body area therebetween and a second image of at least one sports player or other individual, scene or object, wherein at least a part of the second image is visible within the first image. The first image may have an external perimeter in which the second image is fully contained within the perimeter. Alternatively, the majority of the second image can be substantially contained within the first image, such that a portion of the second image extends beyond the perimeter, for example a hand or arm of a sports player reaching for a ball or in a celebratory gesture. The method further includes reproducing the resulting composite image onto a substrate, having or subsequently having imparted thereto, heat transfer capabilities to the substrate, whereby the composite image heat transfer is prepared that has at least a portion of the second image within the defined perimeter of the first image.

In yet another aspect, a heat transfer has a heat transfer substrate exhibiting heat transfer characteristics and an image of a keyboard symbol that has spaced-apart perimeter outlines that define a body area therebetween, a composite image being formed by including an image of a sport player or other individual, scene or object within at least a portion of the keyboard symbol area. A plurality of first image keyboard symbols is provided, with the body area of each such symbol containing a portion of a continuous image concept for the second image.

In a further aspect, the disclosure includes manufacturing and merchandising composite image heat transfer products. When needed, authorization for use of selected images is secured. A first image of a keyboard symbol component is prepared that has a body area, and a second image of a subject is prepared and at least a portion thereof is merged with the first image into its body area to prepare the composite image which is included in preparing a heat transfer including substrate and the composite image. The thus produced composite image heat transfer is applied to a merchandise product which can be merchandised or otherwise transferred to another party.

In a further aspect of the present invention, an image or collection of images can be captured in a database and then a user or customer can select from the group of images for rendering in a keyboard symbol a personalized image which can then be used in the formation of a heat transfer embellishment or label.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a flow diagram of an embodiment of a method by which a composite image heat transfer is made and used;

FIG. 2 is a plan view of a composite image heat transfer embodiment using black and white coloration;

FIG. 3 is a plan view of a composite image heat transfer embodiment using full-color coloration;

FIG. 4 is a plan view of a composite image heat transfer embodiment using colored effect;

FIG. 5 is a plan view of another embodiment having a plurality of keyboard symbols and a faint background image in low resolution watermark fashion;

FIG. 6 is a plan view of another embodiment having a plurality of keyboard symbols and a faint background image in low resolution, including added full resolution imaging;

FIG. 7 is a plan view of a further embodiment having multiple keyboard symbols with a sport figure image crossing the two keyboard symbols in relatively low resolution;

FIG. 8 is a plan view of yet another embodiment wherein a plurality of sports figure images are brought together as a collage within the keyboard symbol, following a so-called colored effect;

FIG. 9 is a plan view of yet another embodiment wherein a collage of sports figure images are brought together within the keyboard symbol, following the black-and-white coloration effect; and

FIG. 10 is a plan view of an additional embodiment illustrating a partial action image of a sport figure.

### DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

An embodiment of a system or method for developing, making, using and marketing composite image heat transfers according to the present disclosure is illustrated in FIG. 1. Graphic images are employed in a typical production. It is anticipated that one of the images of the composite image heat transfer could be a sport personality, celebrity or some other individual or individuals, theme, etc. requiring permission and/or licensing fees for reproduction of the desired image or images. Securing image rights authorization in this regard is illustrated at stage 21. Images can be photographic or artistic works otherwise developed manually or electronically such as by an artist or graphic artist. Stage 21 can also include the assimilation of images into a database for use in creating personalized memorabilia. For example, images of a youth sports team would allow parents to personalize the jersey of their child with images of the child and or other team members. Other images may include images from television or movie characters, famous places, quotations and the like.

Composite image production is illustrated at stage 22. A graphic designer or other artist prepares a keyboard symbol component, as shown in the figures for example, the numeral “8” having a robust width and generally pre-defined dimensions in which to position the images, such as graphic design lettering or balloon-style symbols. The particular symbol selected may also include positional assignments, for example the numeral “8” could have 2, 4, 6, 8 or other positions assigned for images. In this example, if there are 6 positional assignments for images, then the designer would position 6 images (different or the same) in the symbol. Each positional assignment can be of the same general dimensions or can have different dimensions so as to add an additional degree of personalization to the item being created.

This procedure further includes positioning all or a portion of the images for which image rights may have been secured including a second image of at least one subject, personality, individual, scene or object, specifically including a sport personality or player. This positioning is within the confines of the robust width of the keyboard symbol at step 22. A typical keyboard symbol is a number or a letter which could have some significance in the world of sport, either generally or for the subject or subjects selected at authorization stage 21. Typically, the composite image assembly is computer-based, and typically merging or modifying graphic design software assists in this procedure.

At stage 23, the composite image heat transfer is prepared. In doing so, the composite image can be transferred onto a substrate that has otherwise complete heat transfer characteristics, in which event placement of the composite images thereon completes preparation of the heat transfer. Alternatively, the composite image can be placed on a sheet that will be subsequently completed by the addition of further sheets, materials or conditions in order to prepare the full substrate needed for a heat transfer. As a further alternative, the composite image and heat transfer substrate components can be compiled and assembled substantially simultaneously. Whatever sequence of production is followed, the desired composite image heat transfer is prepared upon completion of the stage or phase 23. Transfer sheets and/or paper backing can be included to aid in the movement of the heat transfer from the manufacturing point to the assembly or application area. Typically, the transfer of the composite image is a printing phase, often carried out with digital offset presses, such as Indigo® available from HP of Palo Alto, Calif. Heat transfers can also be produced using conventional flexographic or gravure printing equipment.

A heat transfer application stage is illustrated at 24. The composite image heat transfer is applied to a product or to merchandise that is to be embellished by the composite image, such as a shirt, hat or other apparel item or accessory or souvenir. Transfers can be according to cut singles or roll-to-roll formats. Application equipment at this stage or phase can include heat transfer press machines, for example an Avery Dennison CTB-5 Heat Transfer Bonder. Digital or laser transfer approaches and equipment may be suitable for some products. Composite image heat transfer receiving sheets can be made of a variety of materials, synthetic, natural and blends. These can include polymer or plastic components, cellulosic components, woven fabrics or components, non-woven fabrics or components and fiber components.

Typical merchandise falls in the category of soft goods such as products made from fabric or other pliable or bendable material. Examples include clothing of any type such as garments, headwear and footwear, as well as other products such as banners, flags, covers, bedding, throws and other soft goods. Products that are hard goods could also be embellished with a composite image or composite images. These include merchandise of the memorabilia or promotional type that are suitable for secure heat transfer acceptance. At the conclusion of this heat transfer application stage, the product is ready for merchandising, promotional give-away, or other transfer of ownership, illustrated at stage 25.

It will be appreciated that reproduction of the composite image as a heat transfer can be by printing approaches such as screen printing, lithographic offset printing and digital printing. Various methods of carrying this image to the merchandise item can be employed during the heat transfer application stage 24. Same will vary depending on the substrate and performance requirements. Examples include screen printing a backing ink or backing inks and adhesive, layers behind the composite image, which can be a photographic image. In some instances, the adhesive may be a powder that is spread onto the back of the heat transfer substrate. Essentially any appropriate heat transfer manufacturing method and component details can be practiced.

The keyboard symbol can be numeric or alphabetic or other symbol such as an ampersand, and one or more such keyboard symbols can be included in this same composite image. Although all of the specific illustrations herein depict numeric indicia keyboard symbols, this is not intended to limit the keyboard symbol to any particular type of symbol or specific font style.

Turning to the product illustrated in FIG. 2, the keyboard symbol is a first image indicia 31 configured as the number eight. This numeric indicia has a body portion or area 32 defined between an inside perimeter 33 and an outside perimeter 34; thus, the body portion or area 32 has a width that can be considered robust and provides an opportunity or “artist canvas” for preparation of the composite indicia as discussed herein. At times these are referred to as graphic design symbols or “balloon” symbols. Either or both of the inside perimeter and outside perimeter can include an outline section 35 and 36, respectively, in order to provide contrast that helps emphasize the shape of the keyboard symbol, while emphasizing the first image margins.

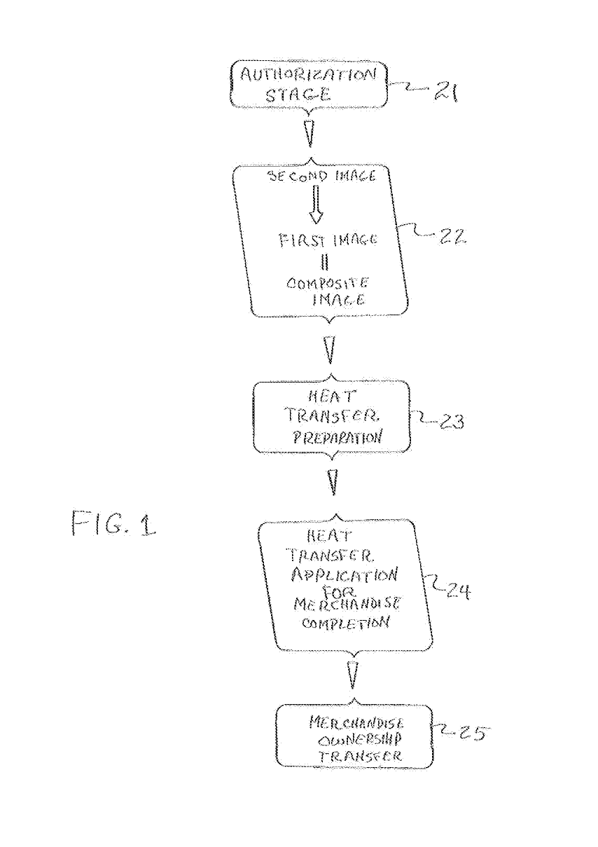

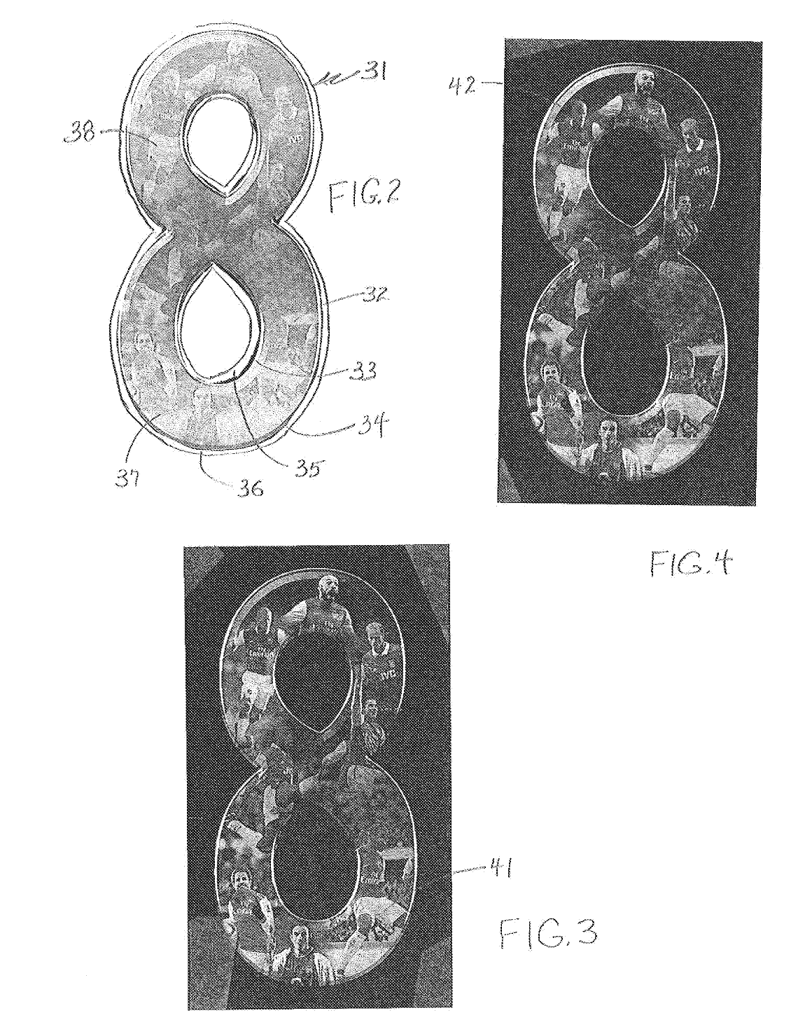

In FIG. 2, a second image 37 is fully within the body portion or area 32 and includes multiple images of sport participants, one being designated at 38. This illustrates a “collage” second image. In this particular embodiment, a black-and-white or grey tone second image is illustrated. FIG. 3 generally follows the features and details of the embodiment of FIG. 2. In FIG. 3, the collage is a full-color second image 41, this particular collage showing multiple sport participants in various action poses and settings. The embodiment illustrated in FIG. 4 generally follows the second image 37 of FIG. 2. However, in this particular embodiment, the grey tone treatment is changed to a single-color treatment which can be termed a red tone second image 42. While the images are shown as generally contained within the boundary or perimeter of the symbol, it should be understood that a portion of the image may occur outside of the boundary or perimeter of the symbol, such as with an outstretched arm or leg.

In FIG. 5, an exemplary embodiment is presented where multiple keyboard symbols are utilized. In this instance, the multiple keyboard symbols are the numeral one followed by the numeral zero, thus displaying the numeral ten, or “10.” This first image is a combination of a first symbol 43 and second symbol 44, shown generally juxtaposed to each other. In this embodiment, the second image comprises two components, a left component of second faint image 45, same being a portion of the right arm of a sport player in an action pose and certain background details. Right component of second faint image 46 includes portions of the sport player that are a continuation of details of the sport player in the left component 45. In FIG. 5, the reference numeral 46 is directly pointing out the head of this particular sport player in his action pose. Background details also are included in faint image format in this right component. This approach illustrates a concept whereby a single subject or collage is continued from one symbol to another symbol, thereby conceptually tying together the two symbols as a single artistic unit. In this illustration, the second image is so faint as to be in the nature of a watermark style.

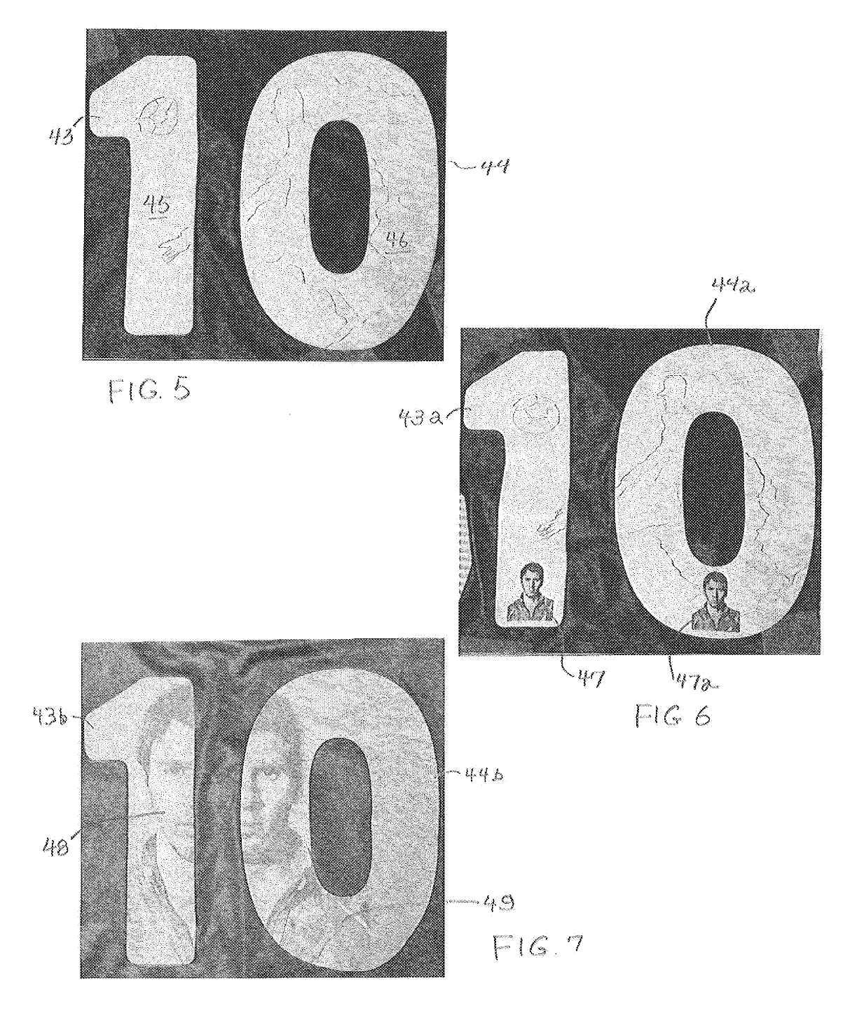

FIG. 6 generally follows FIG. 5. In FIG. 6, full resolution images 47 and 47a are added to each of the first and second symbols 43a, 44a, respectively. When desired, the full resolution image or photographic reproduction can be of the same individual depicted in faint background in the rest of the second image. A different individual or different individuals can be presented.

FIG. 7 illustrates the same symbols, a one and a zero, but provides a different effect for first symbol 43b and second symbol 44b of the second image of this embodiment. The second image has a left component 48 and a right component 49. In this illustrative embodiment, right and left components constitute a split image of a unitary subject, in this case a bust-type image, photograph or shot of a sport player. This low resolution image thus crosses two digits while creating an impression of a full image and while conceptually tying together the two otherwise separate digits. Also in this embodiment, the first and second symbols 43a, 43b provide a background color in those portions of the respective body areas of the multiple component first image members, particularly at those locations within the respective body areas that do not contain the left or right component of the second image. The images, when needed, may be in varying resolutions depending on contrasts desired or required by licensing specifications.

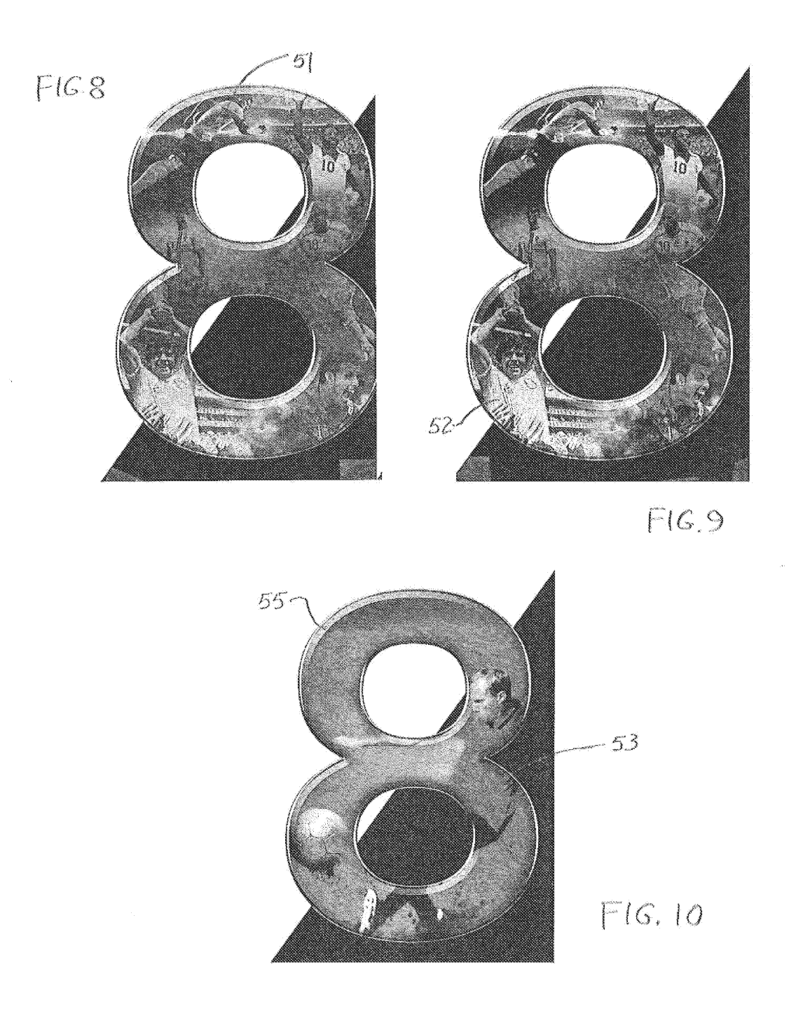

FIG. 8 and FIG. 9 illustrated identical image collages 51, 52 that include photographic reproductions of a collection of different individuals that are in different poses or action situations that can vary across time, subject matter and meaning. Both embodiments embody the single-colored effect, with FIG. 8 being described as yellow toned and FIG. 9 being of the grey scale variety. Illustrations of other tonality varieties include so-called sepia pigmentation.

FIG. 10 depicts a single keyboard symbol, the number eight in this example, that can be considered to be a full color image of a single sport player as an action shot 53 that is positioned within body portion 54 of the first image 55. In this illustration, the body portion 54 has a varied coloration motif, generally in the orange family, in order to provide artistic effect and/or adequate contrast with the action shot 53.

In a specific embodiment, the concept of the present disclosure is the placing of images of a sports player or players in a photo-realistic format into the body of a heat transfer number or letter. This can be a collection of images, or a single image. This can be in color, in colored effect, in black-and-white or other mono-color tone and/or as a full-contrast image, a low-contrast image, or faint image that presents a watermark appearance. The image can be connected across multiple numbers or letters, such as for a two-digit player number. It is recognized that either or both of the first and second images may require licensing and be subject to image use guidelines, and it is contemplated that licensing efforts may be a component of the present disclosure's procedure. In addition, tactile components may be added to the heat transfer such as powders or grains to create a roughened feel, or channels can be created to add additional aesthetic features to the product.

In essence, once the licensing situation is addressed, the user of the present method or procedure will reproduce the licensed image and/or an unlicensed image (the second image) within the first image, which can be a licensed or unlicensed number, letter, or other symbol such as other keyboard symbol in one or more font styles. This provides what can be considered to be the final artwork or the composite image which is then manufactured into a heat transfer using any appropriate method and materials such as those referenced herein. This heat transfer then is adhered to the product to be embellished with the heat transfer and its composite image. For example, the composite image heat transfer can be adhered to a clothing item such as a sports uniform, for example at a location or locations at which an athlete's or official's identifier, such as a player number or name or initials can be positioned on the clothing item. The resulting merchandise then is ready for use and/or sale to the public, for example to fans of a particular sporting personality or team, or other individual.

One aspect of the clothing, products or merchandise according to this disclosure is to produce an “authentic” product that will financially benefit any image-rights holder, the manufacturer and others in the merchandising channels of trade for such products. For example, these products can provide a sports fan with a genuine “collectable” item for use and/or posterity. It will be appreciated that, with the present disclosure, heat transfers are provided with photo imagery that is an integral part of an item that can be sold to the public.

Other embodiments besides those illustrated herein also may be employed without departing from the scope of the present disclosure. For example, non-Latin letters or symbols that are more abstract than those described herein can be employed. Further, other configurations beyond those specifically shown, described or contemplated herein may be employed depending upon the artistic or merchandising objectives or business model.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

What is claimed is:

1. A composite image heat transfer comprising:
a heat transfer substrate exhibiting heat transfer characteristics; and
a composite image on the heat transfer substrate, the composite image being located within at least a portion of a numeric or alphabetic symbol.

2. The heat transfer according to claim 1, wherein the numeric or alphabetic symbol is of a balloon configuration with a body area having a width following the shape of the symbol, and wherein the sport personality image is located within at least a portion of the symbol body area.

3. The heat transfer according to claim 2, wherein the image includes a plurality of individuals or scenes, each being completely or partially within the symbol body area.

4. The heat transfer according to claim 1, wherein the image provides a watermark-type faint image appearance.

5. The heat transfer according to claim 2, wherein the symbol body area and the image are in full color, in a mono-colored scale, in full contrast, low contrast or faint contrast style.

6. The heat transfer according to claim 2, wherein a plurality of numeric or alphabetic symbols are provided, with the body area of each symbol containing a portion of a continuous image concept for the sport personality.

7. The heat transfer according to claim 2, wherein the symbol has a perimeter at an edge portion of the body area, the perimeter having a contrasting appearance when compared with the appearance of the symbol body area.

8. A composite image heat transfer comprising:
a heat transfer substrate exhibiting heat transfer characteristics;
a first image having the shape of a keyboard symbol that has an inside perimeter and an outside perimeter spaced apart from the inside perimeter to define a body area therebetween;
a second image of at least one subject or personality;
the second image is positioned within at least a portion of the first image body area to provide a composite image; and
the composite image is on the heat transfer substrate.

9. The heat transfer according to claim 8, wherein the first image keyboard symbol is at least one numeric or alphabetic symbol, and wherein the subject or personality is a sport player or other sport personality.

10. The heat transfer according to claim 8, wherein the second image includes a plurality of individuals or scenes, each being completely or partially within the symbol body area.

11. The heat transfer according to claim 8, wherein the symbol body area and the image are in full color, in a mono-colored scale, in full contrast, low contrast or faint contrast style.

12. The heat transfer according to claim 8, wherein a plurality of first image keyboard symbols are provided, with the body area of each symbol containing a portion of a continuous image concept for the second image.

13. The heat transfer according to claim 8, wherein the first image keyboard symbol has a perimeter at an edge portion of the body, the perimeter having a contrasting appearance when compared with the appearance of the symbol body area.

14. A method of preparing a composite image heat transfer, comprising:
preparing a composite image of a sport personality within a numeric or alphabetic symbol image;
providing a substrate;
reproducing the composite image on the substrate, the substrate being imparted with heat transfer characteristics before, during or after said reproducing of the composite image thereon; and
thereby providing the composite image heat transfer.

15. The method according to claim 14, wherein said preparing includes providing the numeric or alphabetic symbol in balloon configuration with a body area having a width following the shape of the symbol, and wherein the preparing further includes locating the sport personality image within at least a portion of the body area.

16. The method according to claim 15, wherein said preparing includes providing the sport personality image to include a plurality of individuals or scenes, each being completely or partially within the symbol body area.

17. The method according to claim 15, wherein said preparing includes providing the sport personality image as a watermark-type faint image appearance.

18. The method according to claim 15, wherein said preparing includes providing a plurality of numeric or alphabetic symbols, with the body area of each symbol containing a portion of a continuous image concept for the sport personality.

19. The method according to claim 15, wherein said preparing includes providing the symbol with a perimeter at an edge portion of the body, the perimeter with a contrasting appearance when compared with the appearance of the symbol body area.

20. A method of preparing a composite image heat transfer, comprising:
preparing a first image including first image indicia of a keyboard symbol having spaced-apart perimeter boundaries with a body area therebetween;
preparing a second image of at least one individual;
positioning at least a part of the second image so as to be visible within the first image, thereby providing the composite image;
reproducing the composite image onto a sheet substrate;
imparting heat transfer capability to the sheet substrate; and
whereby the composite image heat transfer is prepared that has the second image within the body area of the first image.

21. The method according to claim 20, wherein said first image preparing selects the numeric or alphabetic symbol to be of a balloon configuration with a body area having a width following the shape of the first image, and said positioning includes locating the second image within at least a portion of the body area.

22. The method according to claim 21, wherein the second image positioning includes selecting a plurality of individuals or scenes, each being completely or partially within the symbol body area.

23. The method according to claim 21, wherein the second image preparing provides a watermark-type faint image appearance.

24. The method according to claim 20, wherein said preparing the first image includes providing a plurality of numeric or alphabetic symbols, and the positioning includes containing a portion within the body area of each symbol, providing a continuous image concept for the second image.

25. The method of claim 20, wherein said preparing the first image includes providing a perimeter at an edge portion of the body area, and providing the perimeter with a contrasting appearance when compared with the appearance of the symbol body area.

26. The method of claim 20, wherein said reproducing is by printing selected from the group consisting of screen printing, lithographic offset printing and digital printing.

27. A method of manufacturing and merchandising composite image heat transfer products, comprising:
securing authorization of images for inclusion in a composite image heat transfer, as needed for any such image;
preparing a first image that is a keyboard symbol component having a width between generally opposing perimeters of the keyboard symbol, the width being a body area;
preparing a second image that is a subject, personality, object, scene, personality or sport player;
electronically merging at least a portion of the second image into the body area of the first image to form a composite image originating from the first and second images;
preparing a heat transfer by printing the composite image onto a substrate exhibiting heat transfer characteristics to form a composite image heat transfer;
applying the composite image heat transfer to a merchandise product; and
transferring ownership of the merchandised product.

28. The method according to claim 27, wherein the first image is selected from the group consisting of a numeric symbol, an alphabetic symbol, an alphanumeric symbol, and combinations thereof, and wherein the second image is a sport subject.
